(19) United States
(12) Patent Application Publication
(10) Pub. No.: US 2024/0253001 A1
(43) Pub. Date: Aug. 1, 2024

(54) METHOD AND APPARATUS FOR HEATING FLUIDIZING AGENT AND USE

(71) Applicant: Teknologian tutkimuskeskus VTT Oy, Espoo (FI)

(72) Inventor: Matti Nieminen, VTT (FI)

(73) Assignee: Teknologian tutkimuskeskus VTT Oy, Espoo (FI)

(21) Appl. No.: 18/562,039

(22) PCT Filed: May 19, 2022
(86) PCT No.: PCT/FI2022/050340

§ 371 Date: Nov. 17, 2023

(30) Foreign Application Priority Data
May 20, 2021 (FI) 20215601

(51) Int. Cl. B01J 8/18; C01B 3/02; C10J 3/48

(52) U.S. Cl. CPC B01J 8/1836; B01J 8/1827; C01B 3/02; C10J 3/48; B01J 2208/00176; B01J 2208/00274; C10J 2300/0946; C10J 2300/1253

(57) ABSTRACT

The invention relates to a method and an apparatus for heating a fluidizing agent for a fluidized bed reactor in which the fluidizing agent is fed to the fluidized bed reactor. The fluidizing agent is heated by heat of the process gas and/or heat of flue gas in at least one heat exchanger in which the heat of the process gas and/or the heat of the flue gas is utilized after the fluidized bed reactor, and the heated fluidizing agent is fed to the bottom of the fluidized bed reactor. Further, the invention relates to the use of the method.

### CROSS-REFERENCE TO RELATED APPLICATIONS

This application is a national phase entry of International Patent Application No. PCT/FI2022/050340 (filed 19 May 2022), which claims priority to Finnish Patent Application No. 20215601 (filed 20 May 2021), the entire disclosures of which are incorporated herein by reference.

### FIELD

The application relates to a method defined in claim 1 and an apparatus defined in claim 11 for heating fluidizing agent. Further, the application relates to a use of the method defined in claim 17.

### BACKGROUND

Known from the prior art is to treat different raw materials in fluidized bed reactors. A fluidizing agent is used in the fluidized bed reactor.

Further, it is known that heat may be recovered from hot gases in different processes.

### OBJECTIVE

The objective is to disclose a new type of method and apparatus for heating a fluidizing agent in a fluidized bed reactor. Further, the objective is to provide different ways to superheat a fluidizing agent, e.g. steam. Further, the objective is to utilize waste heat of the fluidized bed process, e.g. a gasification process.

### SUMMARY

The method and apparatus and use are characterized by what are presented in the claims.

In the method and apparatus, a fluidizing agent is heated for a fluidized bed reactor. The fluidizing agent is heated and fed to the fluidized bed reactor, wherein the fluidizing agent is heated by heat of the process gas and/or heat of flue gas.

### BRIEF DESCRIPTION OF THE DRAWING

The accompanying drawings, which are included to provide a further understanding of the invention and constitute a part of this specification, illustrate some embodiments of the invention and together with the description help to explain the principles of the invention. In the drawings:

FIG. 1 is a flow chart illustration of a process according to one embodiment,

FIG. 2 is a flow chart illustration of a process according to another embodiment,

FIG. 3 is a flow chart illustration of a process according to another embodiment, and

FIG. 4 is a flow chart illustration of a process according to another embodiment.

### DETAILED DESCRIPTION

In the method for heating a fluidizing agent, e.g. steam or other fluidizing agent, for a fluidized bed reactor, the fluidizing agent is heated and fed to the fluidized bed reactor, wherein the fluidizing agent is heated by heat of the process gas and/or heat of flue gas in at least one heat exchanger, in which the heat of the process gas and/or the heat of the flue gas is utilized after the fluidized bed reactor, and the heated fluidizing agent is fed to the bottom of the fluidized bed reactor.

The apparatus for heating a fluidizing agent, e.g. steam or other fluidizing agent, for a fluidized bed reactor may comprise at least one heat exchanger in which the fluidizing agent is heated by heat of the process gas and/or heat of the flue gas and in which the heat of the process gas and/or the heat of the flue gas is utilized after the fluidized bed reactor, and at least one feeding means for feeding the heated fluidizing agent to the bottom of the fluidized bed reactor.

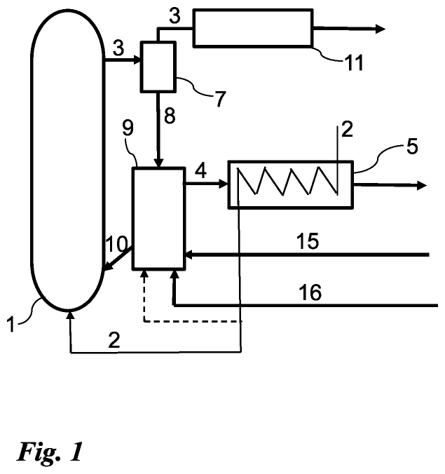

Some embodiments of the method and the apparatus are shown in FIGS. 1-4.

The apparatus comprises the fluidized bed reactor. The fluidized bed reactor may be any reactor having at least one fluidized bed. In the fluidized bed reactor, raw material is treated for forming gas, such as a process gas. The raw material is fluidized with the fluidizing agent in the fluidized bed reactor.

In this context, the fluidizing agent means any suitable fluidizing agent, e.g. steam, gaseous agent, gas mixture or the like or their combination. In one embodiment, the fluidizing agent comprises steam, e.g. superheated steam. In one embodiment, the fluidizing agent is steam, e.g. superheated steam.

In this context, the raw material means any suitable material which can be treated in the fluidized bed reactor. In one embodiment, the raw material may comprise plastic. In one embodiment, the raw material is plastic-based waste.

In one embodiment, the fluidized bed reactor is a fluidized bed gasifier in which raw material is treated for forming gas, such as process gas. In one embodiment, the gasification in the gasifier is performed by steam. The gasification is a process that converts the raw material into gasification products, such as into the gas, e.g. gasification gas. This can be achieved by treating the raw material at suitable temperatures, and for example, with a controlled amount of the steam. Any suitable gasifier may be used in the present process. In one embodiment, the gasifier is a circulating fluidized bed (CFB) reactor. In one embodiment, the gasifier is a bubbling fluidized bed (BFB) reactor. The raw material in the gasification may comprise plastic and other components. The BFB gasifier tolerates aluminium, e.g. aluminium foil, in the raw material.

In one embodiment, the process gas is cooled and the fluidizing agent is heated in the heat exchanger. In one embodiment, the process gas is supplied to the heat exchanger in which the process gas is cooled and the fluidizing agent is heated.

In one embodiment, the process gas is cooled in a cooling device, e.g. in a water quench after the fluidized bed reactor.

In one embodiment, the process gas is supplied from the fluidized bed reactor to a cyclone in which at least bed material is separated, and the process gas is supplied from the cyclone to the heat exchanger in which the process gas is cooled and the fluidizing agent is heated. In one embodiment, the process gas is supplied from the fluidized bed reactor to the cyclone in which at least bed material is separated, and the process gas is discharged from the cyclone. In one embodiment, the process gas is supplied from the fluidized bed reactor to the cyclone in which at least bed material is separated, and the process gas is supplied from the cyclone to a cooling device, e.g. to a water quench the process gas is cooled. In one embodiment, the bed material separated in the cyclone is fed to a bed material heating device.

In one embodiment, the heat exchanger or water quench is located in connection with a pipeline via which the process gas flows from the fluidized bed reactor to a next process step.

In one embodiment, the bed material is recirculated from the fluidized bed reactor to a bed material heating device and from the bed material heating device to the fluidized bed reactor. In one embodiment, the bed material is separated from the process gas and fed to the bed material heating device. In one embodiment, the bed material is separated from the flue gas and fed to the fluidized bed reactor.

In one embodiment, the flue gas, such as the flue gas from the bed material heating device, is cooled and the fluidizing agent is heated in the heat exchanger. In one embodiment, the flue gas is supplied to the heat exchanger, in which the flue gas is cooled and the fluidizing agent is heated.

In one embodiment, the bed material of the fluidized bed reactor is heated in the bed material heating device, e.g. combustor or oxidizer, and the flue gas from the bed material heating device is supplied to the heat exchanger, in which the flue gas is cooled and the fluidizing agent is heated. The flue gas may comprise carbon dioxide and water vapour. In one embodiment, the flue gas consists of carbon dioxide and water vapour.

In one embodiment, the flue gas from the bed material heating device is supplied to a cyclone in which bed material is separated from the flue gas, and the flue gas is supplied to the heat exchanger. In one embodiment, the separated bed material is recirculated from the cyclone to the fluidized bed reactor.

In one embodiment, the apparatus comprises at least two heat exchangers. In one embodiment, the apparatus comprises two heat exchangers, such as the first heat exchanger and the second heat exchanger. In one embodiment, the process gas is cooled and the fluidizing agent is heated in the first heat exchanger, the fluidizing agent is supplied to the second heat exchanger, and the flue gas is cooled and the fluidizing agent is heated in the second heat exchanger. In one embodiment, the first heat exchanger is placed in a pipeline via which the process gas flows from the fluidized bed reactor, for example to a next process step. In one embodiment, the second heat exchanger is placed in a pipeline via which the flue gas flows from the bed material heating device, e.g. from combustor or oxidizer. In one embodiment, the fluidizing agent is heated in the first heat exchanger and heated in the second heat exchanger, and temperature of the fluidizing agent is 400-800° C. after the second heat exchanger. In one embodiment, the fluidizing agent is heated in the first heat exchanger to temperature of 150-400° C., in one embodiment to temperature of 160-350° C., in one embodiment to temperature of 170-250° C., or in one embodiment to temperature of 200-220° C.

In the process any suitable heat exchanger may be used for heating the fluidizing agent and for cooling the process gas and/or the flue gas.

In one embodiment, the apparatus comprises at least one bed material heating device, e.g. combustor or oxidizer, in which the bed material is heated and in which the flue gas is formed. In one embodiment, the bed material is treated and heated at temperature of 780-900° C. in the bed material heating device. Combustion material and combustion air may be fed to the bed material heating device. In one embodiment, the apparatus comprises recirculation means for recirculating the bed material from the fluidized bed reactor to the bed material heating device or via a cyclone to the bed material heating device. In one embodiment, the heat exchanger is located after the bed material heating device, and the flue gas is supplied from the bed material heating device to the heat exchanger where the flue gas is cooled. In one embodiment, the heat exchanger is located after the cyclone which is after the bed material heating device, and the flue gas is supplied from the bed material heating device via the cyclone to the heat exchanger where the flue gas is cooled.

In one embodiment, the apparatus comprises at least one cyclone, and the heat exchanger is located after the cyclone in which the bed material is separated from the process gas and/or from the flue gas, for example after the fluidized bed reactor or the bed material heating device.

In one embodiment, a part of the heated fluidizing agent can be supplied to control a heated bed material feed from the bed material heating device to the fluidized bed reactor.

In one embodiment, the raw material is gasified in the fluidized bed reactor. In one embodiment, the fluidized bed reactor is a gasifier comprising the fluidized bed. In one embodiment, steam is used as the fluidizing agent. In one embodiment, the gasification is carried out at 680-900° C., in one embodiment at 780-900° C.

In one embodiment, the raw material comprising plastic is gasified in the fluidized bed reactor. In one embodiment, the fluidized bed reactor is a gasifier comprising the fluidized bed. In one embodiment, steam is used as the fluidizing agent. In one embodiment, the gasifier is a steam blown fluidized bed gasifier. In one embodiment, the process gas is a product gas the from gasifier. In one embodiment, the gasification is carried out at 680-760° C. For example, in one embodiment, the residence time may be below 10 seconds, in one embodiment 1-10 seconds and in one embodiment 3-10 seconds, in the gasifier.

The raw material comprising plastic may comprise polyolefins and/or recycled plastics. In one embodiment, the raw material consists of polyolefins and/or recycled plastics. In this context, the recycled plastics means any plastic mixture which consists of one or more polymers. The recycled plastics may comprise polyolefins, e.g. polyethylene or polypropylene, and other polymers, and further other components, such as paper, cardboard and/or aluminium material. In one embodiment, the recycled plastics may comprise also PVC plastic. In one embodiment, the gasification process of the raw material comprising recycled plastics needs a superheated steam for the fluidization in the reactor. The superheating requires a lot of energy.

In one embodiment, the process gas after the gasifier comprises olefins, e.g. ethylene and propylene, and the process gas may be rich in olefins. Further, the process gas may comprise aromatics, e.g. benzene and toluene, and other hydrocarbons, e.g. butadiene. Usually, the process gas is a mixture of hydrocarbons.

In one embodiment, the process gas is cooled after the gasifier for killing chemical reactions after the gasification. In one embodiment, the process gas is cooled by a heat exchanger. In one embodiment, the process gas is cooled by a water quench. In one embodiment, reactions are killed rapidly after the gasification by cooling the process gas to temperature of below 600° C., in one embodiment below 580° C. and in one embodiment below 550° ° C., in order to stop chemical reactions. In one embodiment, reactions are killed rapidly after the gasification by cooling the process gas to temperature of 580-600° C. When the reactions are killed, the yield of targeted products, e.g. light olefins, may be increased or maximised. In one embodiment, the reactions are killed in the heat exchanger in which the fluidizing agent is heated. In one embodiment, the reactions are killed before the heat exchanger in which the fluidizing agent is heated, e.g. just after the fluidized bed reactor. In one embodiment, the reactions are killed in the water quench after the fluidized bed reactor.

In one embodiment, the fluidized bed reactor is a calcination device.

In one embodiment, the process gas is cooled to temperature of 560-600° C., in one embodiment 580-600° C., in the heat exchanger. In one embodiment, the process gas is cooled to temperature of 400-430° C. in the heat exchanger if the reactions have been killed before the heat exchanger.

The method and apparatus are based on a continuous process.

In one embodiment, the method and apparatus can be used in a production of hydrocarbons, treatment of plastic containing raw material, gasification, pyrolysis, heat-treatment process, catalytic cracking or their combinations.

Thanks to the invention, high temperature waste heat can be utilized from the flue gas of the bed material heating system and/or from the process gas, e.g. product gas. The heat energy of the flue gas and/or process gas can be converted into the fluidizing agent, e.g. into a superheated steam, which can be recirculated to the fluidized bed reactor. By means of invention, an energy efficiency can be improved in the fluidized bed process.

The method and apparatus offer a possibility to heat the fluidizing agent energy- and cost-effectively. The present invention provides an industrially applicable, simple and affordable way to heat the fluidizing agent. The method and apparatus are easy and simple to realize in connection with production processes.

Further, the recycling of plastics can be improved by means of the invention.

### Examples

FIGS. 1-4 present some embodiments of the process in which a fluidizing agent (2) is heated in a fluidized bed gasification process by utilizing waste heat from flue gas (4) and/or process gas (3). The fluiding agent is a superheated steam.

The apparatus of FIG. 1 comprises a fluidized bed gasifier (1), which is CFB gasifier, and a heat exchanger (5) in which the steam (2) is heated by heat of the flue gas (4). Raw material comprising polyolefins and/or recycled plastics is fed to the gasifier, and the raw material is fluidized together with bed material by means of the heated steam (2) which is fed via the bottom of the gasifier. The raw material is gasified in the gasifier for forming the process gas (3). The process gas is supplied to a cyclone (7) where the bed material (8) is separated from the process gas and fed to a bed material heating device (9). The process gas (3) is cooled in a water quench (11) after the cyclone (7) for chemical killing reactions after the gasification. The reactions are killed rapidly after the gasification by cooling the process gas to temperature of below 600° C. in order to stop chemical reactions. The apparatus comprises the bed material heating device (9), e.g. a combustor or oxidizer, in which the bed material (8) is treated and heated at temperature of 780-900° C. and in which the flue gas (4) is formed, and recirculation means for recirculating the bed material from the gasifier to the bed material heating device. Methane and hydrogen (15) and combustion air (16) are fed to the bed material heating device (9). The heat exchanger (5) is located after the bed material heating device (9), and the flue gas (4) is supplied from the bed material heating device to the heat exchanger where the flue gas (4) is cooled and the steam (2) is heated. The flue gas comprises carbon dioxide and water vapour. The bed material (10) is recirculated from the bed material heating device (9) back to the gasifier (1).

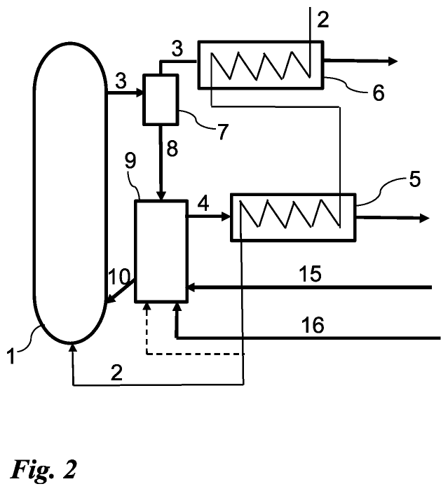

The apparatus of FIG. 2 comprises a fluidized bed gasifier (1), which is CFB gasifier, and two heat exchangers (6,5) in which the steam (2) is heated by heat of the process gas (3) and flue gas (4). Raw material comprising polyolefins and/or recycled plastics is fed to the gasifier, and the raw material is fluidized together with bed material by means of the heated steam (2) which is fed via the bottom of the gasifier. The raw material is gasified in the gasifier for forming the process gas (3). The process gas is supplied to a cyclone (7) where the bed material (8) is separated from the process gas and fed to a bed material heating device (9). The process gas (3) is cooled in the first heat exchanger (6) after the cyclone (7) for killing chemical reactions after the gasification. The reactions are killed by cooling the process gas to temperature of below 600° C. in order to stop chemical reactions. Simultaneously, the steam (2) is heated in the first heat exchanger (6). The apparatus comprises the bed material heating device (9), e.g. a combustor or oxidizer, in which the bed material (8) is treated and heated at temperature of 780-900° C. and in which the flue gas (4) is formed, and recirculation means for recirculating the bed material from the gasifier to the bed material heating device. Methane and hydrogen (15) and combustion air (16) are fed to the bed material heating device (9). The steam (2) is supplied from the first heat exchanger (6) to the second heat exchanger (5). The second heat exchanger (5) is located after the bed material heating device (9), and the flue gas (4) is supplied from the bed material heating device to the second heat exchanger where the flue gas (4) is cooled and the pre-heated steam (2) is further heated. The flue gas comprises carbon dioxide and water vapour. Temperature of the steam (2) is 400-800° C., e.g. 700-800° C., after the second heat exchanger (5). The bed material (10) is recirculated from the bed material heating device (9) back to the gasifier (1).

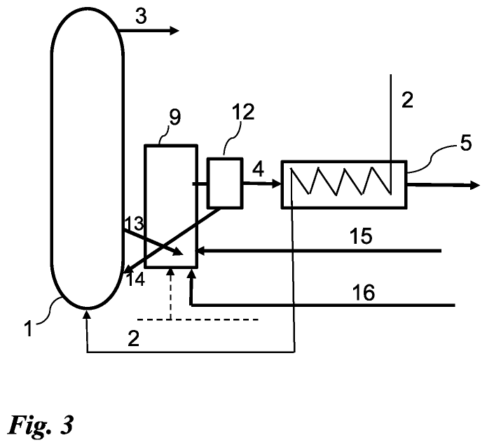

The apparatus of FIG. 3 comprises a fluidized bed gasifier (1), which is BFB gasifier, and a heat exchanger (5) in which the steam (2) is heated by heat of the flue gas (4). Raw material comprising polyolefins and/or recycled plastics is fed to the gasifier, and the raw material is fluidized together with bed material by means of the superheated steam (2) which is fed via the bottom of the gasifier. The raw material is gasified in the gasifier for forming the process gas (3). The process gas is supplied out from the gasifier. The process gas (3) is cooled by a water quench for killing chemical reactions after the gasification. The reactions are killed rapidly after the gasification by cooling the process gas to temperature of below 600° C. in order to stop chemical reactions. The apparatus comprises the bed material heating device (9), e.g. a combustor or oxidizer, to which bed material (13) is recirculated from the gasifier and in which the bed material (13) is treated and heated at temperature of 780-900° C. and in which the flue gas (4) is formed, and recirculation means for recirculating the bed material from the gasifier to the bed material heating device. Methane and hydrogen (15) and combustion air (16) are fed to the bed material heating device (9). The heated bed material is supplied to a cyclone (12) where the bed material (14) is separated from the flue gas and fed to the gasifier (1). The heat exchanger (5) is located after the cyclone (12), and the flue gas (4) is supplied from the bed material heating device via the cyclone to the heat exchanger where the flue gas (4) is cooled and the steam (2) is heated. The flue gas comprises carbon dioxide and water vapour.

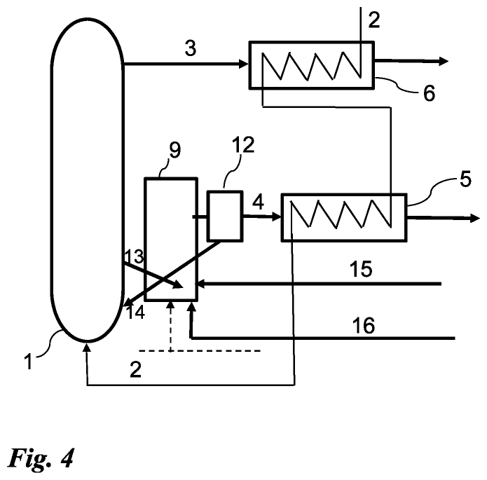

The apparatus of FIG. 4 comprises a fluidized bed gasifier (1), which is BFB gasifier, and two heat exchangers (6,5) in which the steam (2) is heated by heat of the process gas (3) and flue gas (4). Raw material comprising polyolefins and/or recycled plastics is fed to the gasifier, and the raw material is fluidized together with bed material by means of the superheated steam (2) which is fed via the bottom of the gasifier. The raw material is gasified in the gasifier for forming the process gas (3). The process gas is cooled by a water quench for killing chemical reactions after the gasification. The reactions are killed rapidly after the gasification by cooling the process gas to temperature of below 600° C. in order to stop chemical reactions. After that the process gas (3) is supplied to the first heat exchanger (6) in which the process gas is cooled to temperature of 400-430° C. and the steam (2) is heated. The apparatus comprises the bed material heating device (9), e.g. a combustor or oxidizer, to which bed material (13) is recirculated from the gasifier and in which the bed material (13) is treated and heated at temperature of 780-900° C. and in which the flue gas (4) is formed, and recirculation means for recirculating the bed material from the gasifier to the bed material heating device. Methane and hydrogen (15) and combustion air (16) are fed to the bed material heating device (9). The heated bed material is supplied to a cyclone (12) where the bed material (14) is separated from the flue gas and fed back to the gasifier (1). The second heat exchanger (5) is located after the cyclone (12), and the flue gas (4) is supplied from the bed material heating device via the cyclone to the second heat exchanger where the flue gas (4) is cooled and the pre-heated steam (2) is further heated. The flue gas comprises carbon dioxide and water vapour. Temperature of the steam (2) is 400-800° C., e.g. 700-800° ° C., after the second heat exchanger (5).

In the apparatuses of FIGS. 1-4, a part of the heated steam (2) may be supplied to control the heated bed material feed from the bed material heating device (9) to the fluidized bed reactor (1).

Any suitable devices and equipments can be used in the processes of FIGS. 1-4.

The method and apparatus are suitable in different embodiments for heating different fluidizing agents and for utilizing waste heat of the gases in different fluidized bed processes.

The invention is not limited merely to the examples referred to above; instead many variations are possible within the scope of the inventive idea defined by the claims.

1. A method for heating a fluidizing agent for a fluidized bed reactor in which the fluidizing agent is fed to the fluidized bed reactor, wherein the method comprises
treating raw material comprising plastic by gasifying in the fluidized bed reactor selected from a fluidized bed gasifier having at least one fluidized bed comprising a bed material to form process gas,
heating the fluidizing agent which is steam by heat of the process gas and cooling the process gas in a first heat exchanger, supplying the fluidizing agent to a second heat exchanger, and heating the fluidizing agent by heat of flue gas and cooling the flue gas in the second heat exchanger wherein the heat of the process gas and the heat of the flue gas formed in a bed material heating device is utilized after the fluidized bed reactor, and
feeding the heated fluidizing agent to a bottom of the fluidized bed reactor.

2. (canceled)

3. The method according to claim 1, wherein the process gas is supplied to the heat exchanger in which the process gas is cooled and the fluidizing agent is heated.

4. The method according to claim 1, wherein the process gas is supplied from the fluidized bed reactor to a cyclone in which at least bed material is separated, and the process gas is supplied from the cyclone to the heat exchanger in which the process gas is cooled and the fluidizing agent is heated.

5. The method according to claim 1, wherein the process gas is a product gas from a gasifier.

6. The method according to claim 1, wherein the flue gas is supplied to the heat exchanger, in which the flue gas is cooled and the fluidizing agent is heated.

7. The method according to claim 1, wherein the bed material of the fluidized bed reactor is heated in the bed material heating device, and the flue gas from the bed material heating device is supplied to the heat exchanger, in which the flue gas is cooled and the fluidizing agent is heated.

8. The method according to claim 1, wherein the flue gas from the bed material heating device is supplied to a cyclone in which bed material is separated from the flue gas, and the flue gas is supplied to the heat exchanger.

9-10. (canceled)

11. An apparatus for heating a fluidizing agent for a fluidized bed reactor, in which the apparatus comprises the fluidized bed reactor and the fluidizing agent is fed to the fluidized bed reactor, wherein
the fluidized bed reactor is a fluidized bed gasifier having at least one fluidized bed comprising a bed material in which raw material comprising plastic is treated by gasifying to form process gas, and
the apparatus comprises at least one bed material heating device in which a flue gas is formed, and at least two heat exchangers in which the fluidizing agent which is steam is heated by heat of the process gas and the process gas is cooled in a first heat exchanger and the fluidizing agent is heated by heat of the flue gas and the flue gas is cooled in a second heat exchanger, wherein the heat of the process gas and the heat of the flue gas is utilized after the fluidized bed reactor, and
at least one feeding means for feeding the heated fluidizing agent to a bottom of the fluidized bed reactor.

12. The apparatus according to claim 11, wherein the apparatus comprises the bed material heating device in which the bed material is heated.

13. The apparatus according to claim 11, wherein the heat exchanger is arranged after the bed material heating device in which the bed material of the fluidized bed reactor is heated and from which the flue gas is supplied to the heat exchanger.

14. The apparatus according to claim 11, wherein the apparatus comprises at least one cyclone, and the heat exchanger is arranged after the cyclone in which the bed material is separated from the process gas and from the flue gas.

15-16. (canceled)

17. A use of the method according to claim 1, wherein the method is used in a production of hydrocarbons, treatment of plastic containing raw material, gasification, pyrolysis, heat-treatment process, catalytic cracking or their combinations.
